(19) United States
(12) Patent Application Publication
(10) Pub. No.: US 2014/0160955 A1
(43) Pub. Date: Jun. 12, 2014

(54) Method for Validating Radio-Frequency Self-Interference of Wireless Electronic Devices

(71) Applicant: APPLE INC., Cupertino, CA (US)

(72) Inventors: Nicholas W. Lum, Santa Clara, CA (US); Anh Q. Luong, Santa Clara, CA (US)

(73) Assignee: Apple Inc., Cupertino, CA (US)

(21) Appl. No.: 13/712,713

(22) Filed: Dec. 12, 2012

(51) Int. Cl. H04W 24/06

(52) U.S. Cl. CPC H04W 24/06
USPC 370/252

(57) ABSTRACT

A test system for testing a wireless electronic device is provided. The test system may include a test host and a tester. The test host may instruct a wireless electronic device under test (DUT) to transmit radio-frequency uplink signals in selected uplink resource blocks of an uplink channel in a desired Long Term Evolution (LTE) frequency band. The tester may convey radio-frequency test data to the DUT in a selected downlink resource block of a downlink channel in the desired LTE frequency band. The DUT may measure data reception throughput values associated with the test data. The test host may compare the measured data reception throughput values to threshold data reception throughput values to characterize the radio-frequency performance of the DUT. The test system may test the radio-frequency performance of the DUT for test data in some or all downlink resource blocks of the downlink channel.

### BACKGROUND

This invention relates generally to electronic devices having wireless communications circuitry, and more particularly, to testing wireless communications circuitry in electronic devices.

Electronic devices such as portable computers and cellular telephones are often provided with wireless communications circuitry. The wireless communications circuitry is operable to transmit and receive radio-frequency signals. The wireless communications circuitry includes duplexer circuitry that separates uplink and downlink signal paths. The wireless communications circuitry wirelessly communicates using a communications protocol. The wireless communications circuitry transmits and receives radio-frequency signals in a communications band associated with the communications protocol.

It can be challenging to design and manufacture electronic devices while ensuring that each electronic device provides satisfactory performance. For example, manufacturing tolerances and other sources of error can introduce variance into electronic devices that degrade performance. It is generally desirable to test each electronic device to ensure that wireless communications circuitry provides satisfactory performance.

Conventional test systems that test electronic devices can produce imprecise measurements. It would therefore be desirable to provide improved test systems for testing wireless communications circuitry.

### SUMMARY

Electronic devices may include wireless communications circuitry. The wireless communications circuitry may include radio-frequency amplifier circuitry, radio-frequency transceiver circuitry, baseband circuitry, front-end circuitry, and antenna structures. The wireless communications circuitry may accommodate communications in one or more frequency bands such as a Long Term Evolution (LTE) frequency band. The frequency band may be partitioned into a number of resource blocks that may be organized into channels identified by respective channel numbers. The channels may include uplink and downlink channels. Resource blocks within uplink channels may be referred to as uplink resource blocks, whereas resource blocks within downlink channels may be referred to as downlink resource blocks.

Test equipment in a test system may be used to perform radio-frequency testing such as pass-fail testing on a wireless electronic device to determine whether the wireless electronic device passes radio-frequency isolation requirements between transmit (uplink) and receive (downlink) paths. The test equipment may include a test host and a tester. The test equipment may configure the wireless communications circuitry for communications using a selected frequency band. The test equipment may configure the wireless communications circuitry for communications in a selected communications channel within the frequency band. The test equipment may instruct the wireless communications circuitry to continuously transmit radio-frequency uplink signals using one or more resource blocks in the frequency band.

If desired, the test equipment may instruct the wireless communications circuitry to continuously transmit radio-frequency uplink signals in the selected uplink resource block at a maximum output power level of the wireless communications circuitry. The maximum output power level may be adjusted based on how many resource blocks are used for communications.

The test equipment may transmit radio-frequency downlink signals (sometimes referred to as radio-frequency data signals) to the wireless communications circuitry in a selected downlink resource block in the frequency band. The test equipment may transmit additional radio-frequency downlink signals to the wireless communications circuitry in an additional downlink resource block. If desired, additional testing may be subsequently performed on additional downlink resource blocks (e.g., during subsequent time periods).

The test equipment may determine whether uplink signals transmitted by the wireless communications circuitry interfere with downlink signals received from the test equipment at the wireless communications circuitry using data reception metrics such as data reception throughput. The data reception throughput value may be measured by the wireless electronic device. The test equipment may instruct the wireless communications circuitry to transmit data reception throughput values to the test equipment over a control path or a wireless communications link (e.g., by communicating using the Long Term Evolution frequency band).

The test equipment may compare the data reception throughput values for each tested resource block to threshold values. In response to determining that one or more of the data reception throughput values are less than the threshold values, the test equipment may identify the wireless communications circuitry as failing test operations. If desired, the test equipment may notify a user that the wireless electronic device fails testing.

Further features of the present invention, its nature and various advantages will be more apparent from the accompanying drawings and the following detailed description.

### BRIEF DESCRIPTION OF THE DRAWINGS

FIG. 1 is a diagram of an illustrative electronic device with wireless communications circuitry that may be used to communicate with a base station in accordance with an embodiment of the present invention.

FIG. 2 is a diagram of an illustrative radio frame that may be transmitted by wireless communications circuitry during testing in accordance with an embodiment of the present invention.

FIG. 3 is a diagram showing how wireless communications circuitry may transmit radio-frequency signals using the Orthogonal Frequency-Division Multiplexing (OFDM) scheme during testing in accordance with an embodiment of the present invention.

FIG. 4 is a diagram showing how wireless communications circuitry may communicate using one or more resource blocks of a radio-frequency channel during testing in accordance with an embodiment of the present invention.

FIG. 5 is a graph showing how an electronic device that transmits radio-frequency signals with maximum uplink output power may produce uplink signals that interfere with communications in downlink resource blocks of a channel identified by a channel number in a communications band in accordance with an embodiment of the present invention.

FIG. 6 is a graph showing how an electronic device that produces radio-frequency signals in multiple uplink resource blocks of a communications band may produce uplink signals that interfere with communications in downlink resource blocks of the communications band in accordance with an embodiment of the present invention.

FIG. 7 is a diagram of an illustrative test system for testing a wireless electronic device using a wired connection in accordance with an embodiment of the present invention.

FIG. 8 is a diagram of an illustrative test system including test equipment for testing a wireless electronic device using a wireless connection in accordance with an embodiment of the present invention.

FIG. 9 is a flow chart of illustrative steps that may be performed by test equipment to characterize the radio-frequency performance of a device under test in accordance with an embodiment of the present invention.

FIG. 10 is a flow chart of illustrative steps that may be performed by a wireless electronic device under test to measure data reception throughput in response to receiving test data from test equipment in accordance with an embodiment of the present invention.

FIG. 11 is an illustrative graph showing how data reception throughput values measured by a wireless electronic device under test for varying downlink signal power levels may be compared to a data reception throughput threshold by a test host in accordance with an embodiment of the present invention.

FIG. 12 is an illustrative graph showing how stored downlink power levels may be compared a downlink power level threshold by a test host in accordance with an embodiment of the present invention.

### DETAILED DESCRIPTION

This relates generally to wireless communications, and more particularly, to systems and methods for testing wireless communications circuitry.

Electronic devices that include wireless communications circuitry may be portable electronic devices such as laptop computers or small portable computers of the type that are sometimes referred to as ultraportables. Portable electronic devices may also be somewhat smaller devices. The wireless electronic devices may be, for example, cellular telephones, media players with wireless communications capabilities, handheld computers (also sometimes called personal digital assistants), remote controllers, global positioning system (GPS) devices, tablet computers, and handheld gaming devices. Wireless electronic devices such as these may perform multiple functions. For example, a cellular telephone may include media player functionality and may have the ability to run games, email applications, web browsing applications, and other software.

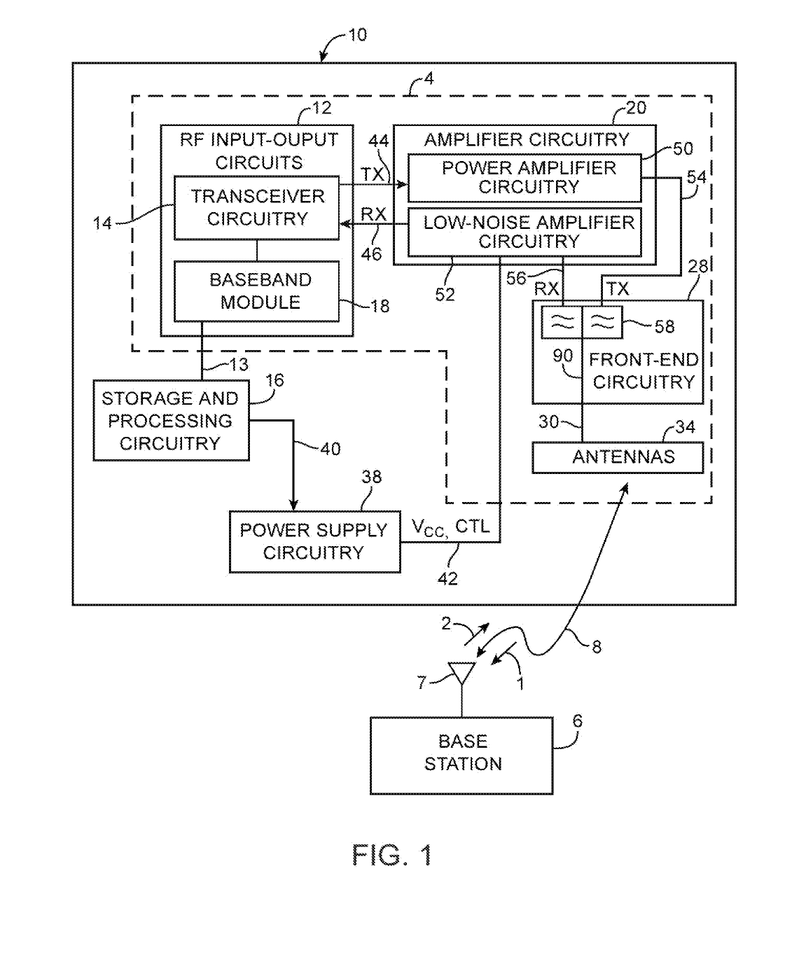

FIG. 1 shows an illustrative electronic device that includes wireless communications circuitry. As shown in FIG. 1, wireless communications circuitry 4 in device 10 may communicate with a base station 6 over wireless communications link 8. Wireless communications link 8 may be established between base station 6 and wireless communications circuitry 4 and may serve as a data connection over which device 10 may send data to and receive data from base station 6. Radio-frequency data may be sent over communications link 8 in an uplink direction (as indicated by arrow 1) from wireless communications circuitry 4 to base station 6. Radio-frequency data may be sent over communications link 8 in a downlink direction (as indicated by arrow 2) from base station 6 to wireless communications circuitry 4. Communications link 8 may be established and maintained using cellular telephone network standards such as the Long Term Evolution (LTE) protocol (as an example).

Wireless communications circuitry 4 may include one or more antennas such as antenna structures 34 and may include radio-frequency (RF) input-output circuits 12. During signal transmission operations, circuitry 12 may supply radio-frequency signals that are transmitted by antennas 34. During signal reception operations, circuitry 12 may accept radio-frequency signals that have been received by antennas 34.

Wireless communications circuitry 4 may support communications over any suitable wireless communications bands. For example, wireless communications circuitry 4 may be used to cover communications frequency bands such as cellular telephone voice and data bands at 850 MHz, 900 MHz, 1800 MHz, 1900 MHz, and the communications band at 2100 MHz band, the Wi-Fi® (IEEE 802.11) bands at 2.4 GHz and 5.0 GHz (also sometimes referred to as wireless local area network or WLAN bands), the Bluetooth® band at 2.4 GHz, the global positioning system (GPS) band at 1575 MHz, and the Global Navigation Satellite System (GLONASS) band at 1602 MHz. The wireless communications bands used by device 10 may include the so-called LTE (Long Term Evolution) bands. The LTE bands are numbered (e.g., 1, 2, 3, 4, etc.) and are sometimes referred to as E-UTRA operating bands. Each LTE band may be partitioned into subsets of frequencies that are sometimes referred to as channels having respective channel numbers. Each channel may be further partitioned into subsets of frequencies sometimes referred to as resource blocks.

Wireless communications circuitry 4 may be used to cover these communications bands and other suitable communications bands with proper configuration of antenna structures 34. Any suitable antenna structures may be used to implement antenna structures 34. For example, wireless communications circuitry 4 may have one antenna or may have multiple antennas. The antennas in wireless communications circuitry 4 may each be used to cover a single communications band or each antenna may cover multiple communications bands. If desired, one or more antennas may cover a single band while one or more additional antennas are each used to cover multiple bands. Wireless communications circuitry 4 may transmit and receive radio-frequency signals in a number of communications bands simultaneously.

Device 10 may include storage and processing circuitry such as storage and processing circuitry 16. Storage and processing circuitry 16 may include one or more different types of storage such as hard disk drive storage, nonvolatile memory (e.g., flash memory or other electrically-programmable-read-only memory), volatile memory (e.g., static or dynamic random-access-memory), etc. Storage and processing circuitry 16 may be used in controlling the operation of device 10. Processing circuitry in circuitry 16 may be based on processors such as microprocessors, microcontrollers, digital signal processors, dedicated processing circuits, power management circuits, audio and video chips, radio-frequency transceiver processing circuits, radio-frequency integrated circuits of the type that are sometimes referred to as baseband modules, and other suitable integrated circuits.

Storage and processing circuitry 16 may be used in implementing suitable communications protocols (sometimes referred to as radio access technologies). Communications protocols that may be implemented using storage and processing circuitry 16 include internet protocols, wireless local area network protocols (e.g., IEEE 802.11 protocols—sometimes referred to as Wi-Fi®), protocols for other short-range wireless communications links such as the Bluetooth® protocol, protocols for handling 2G cellular telephone communications protocols such as GSM (Global System for Mobile Communications) and CDMA (Code Division Multiple Access), 3G cellular telephone communications protocols such as UMTS (Universal Mobile Telecommunications System) and EV-DO (Evolution-Data Optimized), 4G cellular telephone communications protocols such as LTE, etc. Communications using a selected communications protocol may be performed over an associated communications band (e.g., communications using the LTE communications protocol may be performed over an LTE band, etc.).

Data signals that are to be transmitted by device 10 may be provided to baseband module 18. Baseband processor 18 may receive signals from storage and processing circuitry 16 via path 13 to be transmitted over antenna 34. Baseband processor 18 may provide signals that are to be transmitted to transmitter circuitry within radio-frequency transceiver circuitry 14. Wireless communications circuitry 4 may include amplifier circuitry 20. Amplifier circuitry 20 may include power amplifier circuitry 50, low-noise amplifier circuitry 52, and any other desired circuitry for amplifying radio-frequency signals. The transmitter circuitry within transceiver circuitry 14 may be coupled to power amplifier circuitry 50 via transmit path 44. Receiver circuitry within radio-frequency transceiver circuitry 14 may be coupled to low-noise amplifier circuitry 52 via receive path 46.

Path 13 may convey control signals from storage and processing circuitry 16 to input-output circuits 12. These control signals may be used to control the power of the radio-frequency signals that the transmitter circuitry within transceiver circuitry 14 supplies to power amplifier circuitry 50. For example, the control signals may be provided to a variable gain amplifier located inside transceiver circuitry 14 that controls the power of the radio-frequency signals supplied to power amplifier circuitry 50. The control signals may also be used to control the transmit frequency for radio-frequency signals provided to power amplifier circuitry 50 over transmit path (e.g., the control signals may instruct transceiver circuitry 14 to generate radio-frequency signals having a selected frequency for transmission). For example, the control signals may control transceiver circuitry 14 to communicate in one or more desired resource blocks within a channel identified by a channel number in a frequency band such as an LTE frequency band.

During data transmission, power amplifier circuitry 50 in amplifier circuitry 20 may boost the output power of transmitted signals to a sufficiently high level to ensure adequate signal transmission. Amplifier circuitry 20 (e.g., power amplifier circuitry 50 and low-noise amplifier circuitry 52) may include any number of electrical components such as operational amplifiers, transistors, and any other desired components for amplifying signals. Power amplifier circuitry 50 may supply signals for transmission to front-end circuitry 28 over transmit line 54.

Radio-frequency front-end circuitry 28 may include filters such as duplexer 58. Duplexer 58 may route signals for transmission (e.g., uplink signals) from transmit path 54 to antenna structures 34 via output path 30. Duplexer 58 may serve to isolate transmit (uplink) and receive (downlink) paths of wireless communications circuitry 4. Radio-frequency front-end circuitry 28 may, if desired, include matching circuitry having a network of passive components such as resistors, inductors, and capacitors that ensure that antenna structures 34 are impedance matched to the rest of wireless communications circuitry 4.

Wireless signals that are received by antenna structures 34 (e.g., downlink signals) may be conveyed to duplexer 58 over output path 30. Duplexer 58 may route downlink signals received from antennas 34 to low-noise amplifier circuitry 52 via path 56. Downlink signals received by antennas 34 may be amplified by low-noise amplifier circuitry 52. Low-noise amplifier circuitry 52 may pass received downlink signals to receiver circuitry in transceiver circuitry 14 via receive path 46.

Wireless communications circuitry 4 may be used to provide data to storage and processing circuitry 16 via path 13. Data that is conveyed to circuitry 16 from wireless communications circuitry 4 may include raw and processed data. Raw data may, for example, include downlink data received using wireless communications protocols. The processed data conveyed to circuitry 16 from wireless communications circuitry 4 may include data associated with radio-frequency performance metrics for received signals such as received power, bit error rate, data reception throughput, and other information that is reflective of the performance of wireless circuitry 4. For example, baseband module 18 may monitor and process raw data to generate radio-frequency performance metrics.

Storage and processing circuitry 16 may issue commands that direct wireless communications circuitry 4 to identify data reception throughput of signals received from antennas 34 (e.g., data reception throughput of signals provided to transceiver circuitry 14 via receive path 46). Processed data supplied by wireless communications circuitry 4 may be used to characterize the radio-frequency performance of wireless communications circuitry 4. Data conveyed to storage and processing circuitry 16 from wireless communications circuitry 4 may be provided to external equipment such as external test equipment.

Device 10 may include adjustable power supply circuitry such as power supply circuitry 38. Adjustable power supply circuitry 38 may be controlled by control signals received over control path 40. The control signals may be provided to adjustable power supply circuitry 38 from storage and processing circuitry 16 or any other suitable control circuitry (e.g., circuitry implemented in baseband module 18, circuitry in transceiver circuits 14, etc.). Power supply circuitry 38 may supply control signals CTL to amplifier circuitry 20 over path 42. For example, power supply circuitry 38 may supply control signals CTL to amplifier circuitry 20 that instruct amplifier circuitry 20 to operate in a low gain mode or a high gain mode. Power supply circuitry 38 may also supply bias voltages V_{CC} to amplifier circuitry 20 over path 42.

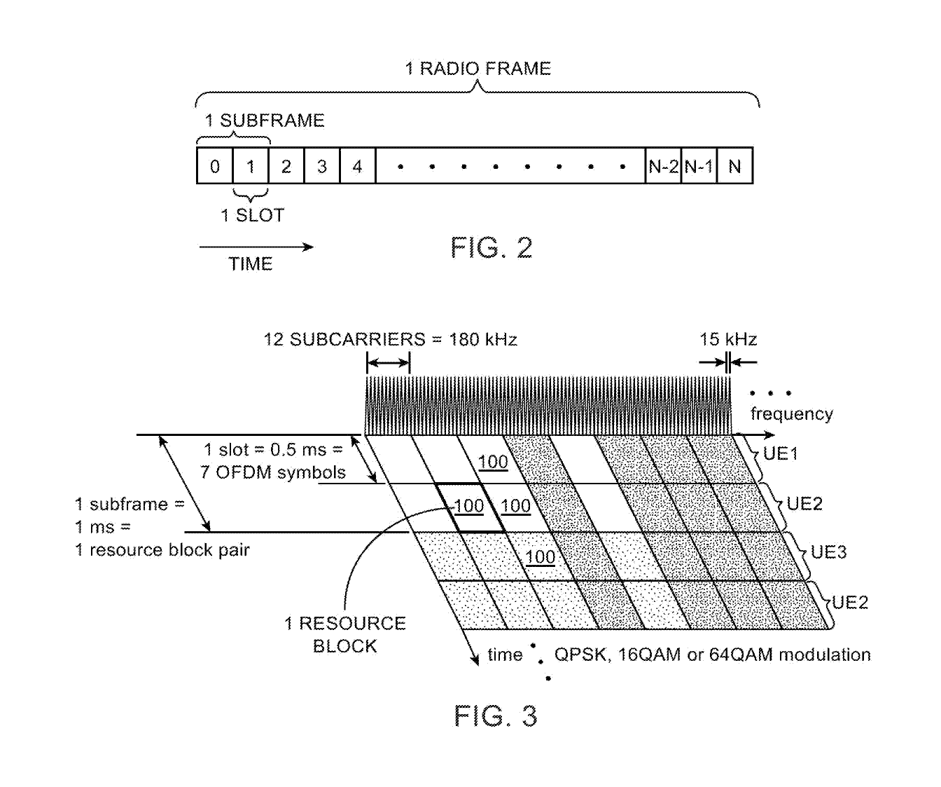

Radio-frequency signals transmitted and received by the wireless communications circuitry 4 operating in accordance with the LTE protocol may, for example, be organized in time to form a radio frame structure that is illustrated in FIG. 2. As shown in FIG. 2, a radio frame may be partitioned into subframes, each of which can be divided into two time slots (e.g., each radio frame may include N time slots). As an example, the radio frame may include ten subframes, each of which includes two 0.5 ms time slots, totaling 20 time slots or 10 ms per radio frame. In general, each radio frame may include any number of subframes, each of which may include any suitable number of time slots having any desired duration.

The LTE communications protocol uses an Orthogonal Frequency-Division Multiplexing (OFDM) digital modulation scheme. The OFDM scheme is a type of frequency-division multiplexing scheme in which a large number of closely-spaced orthogonal subcarriers are used to carry data. Different variants of the OFDM scheme may be used for uplink signal transmission and downlink signal transmission, respectively. For example, downlink signals may be modulated using an Orthogonal Frequency Multiple Access (OFDMA) scheme and uplink signals may be modulated using a Single-Carrier Frequency Division Multiple Access (SC-FDMA) scheme. The closely-spaced orthogonal subcarriers may sometimes be referred to as frequency subcarriers, because each subcarrier may correspond to a range of frequencies (e.g., a range of frequencies having a bandwidth of 15 kHz). The data in each subcarrier may be modulated using respective digital modulation schemes such as quadrature phase shift keying (QPSK) and quadrature amplitude modulation (e.g., 16-QAM and 64-QAM).

As shown in FIG. 3, a designated user device may be given permission to transmit uplink signals during each time slot. For example, a first user device UE1 may transmit uplink signals to a corresponding base station during a first time period, a second user device UE2 may transmit uplink signals to the base station during a second time period, a third user device UE3 may transmit uplink signals to the base station during a third time period, etc. In another suitable arrangement, a base station may broadcast downlink signals intended for more than one user device during a given time slot (e.g., LTE may implement Orthogonal Frequency-Division Multiple Access for downlink transmission).

A wireless electronic device such as device 10 may transmit simultaneously in multiple resource blocks 100 during each time slot. Each time slot is partitioned in time into a number of OFDM symbols. A resource block may serve as a basic scheduling unit that is defined as a set of consecutive OFDM symbols in the time domain and a set of consecutive frequency subcarriers in the frequency domain. For example, a resource block such as resource block 100 may be defined as 7 consecutive OFDM symbols in the time domain and 12 consecutive frequency subcarriers in the frequency domain. The set of consecutive OFDM symbols used to define a resource block may depend on a parameter such as a normal or extended Cyclic Prefix. Each resource block 100 may, for example, measure 0.5 ms by 180 kHz (i.e., assuming a subcarrier spacing of 15 kHz).

Each LTE frequency band (e.g., LTE band 1, LTE band 2, etc.) may include an associated uplink band and an associated downlink band. As an example, LTE band 1 has an uplink band from 1920-1980 MHz and a downlink band from 2110-2170 MHz. As another example, LTE band 5 has an uplink band from 824-849 MHz and a downlink band from 869-894 MHz. During communications operations, a wireless electronic device such as device 10 may transmit radio-frequency signals in the uplink band associated with a desired LTE frequency band and may receive radio-frequency signals in the downlink band associated with the desired LTE frequency band. For example, device 10 may receive radio-frequency signals in the downlink band associated with the desired LTE frequency band while continuously transmitting radio-frequency signals in the uplink band associated with the desired LTE frequency band.

Device 10 may transmit radio-frequency signals over a range of frequencies within a selected uplink band (this range of frequencies in a selected uplink band may sometimes be referred to as an uplink channel having an associated channel bandwidth). For example, a device 10 that is configured to transmit radio-frequency signals using LTE band 1 may be configured to transmit signals in an uplink channel centered at 1950 MHz with a channel bandwidth of 10 MHz (e.g., device 10 may transmit signals in a channel between frequencies 1945 MHz and 1955 MHz). In general, a device 10 that is configured to transmit signals using LTE band 1 may transmit signals in an uplink channel centered at any frequency from 1920-1980 MHz given that the channel bandwidth does not include frequencies outside of the frequency range of LTE band 1. Device 10 may receive radio-frequency signals over a range of frequencies within a selected downlink band (this range of frequencies in a selected downlink band may sometimes be referred to as a downlink channel having an associated channel bandwidth).

Different LTE bands (e.g., LTE band 1, LTE band 2, etc.) may each require device 10 to transmit and receive radio-frequency signals having selected channel bandwidths. For example, a device 10 that is configured to transmit radio-frequency signals in the uplink band of LTE band 1 may be required to transmit radio-frequency signals having a channel bandwidth of 5 MHz, 10 MHz, 15 MHz, or 20 MHz. In another example, a device 10 that is configured to receive radio-frequency signals in the uplink band of LTE band 5 may be required to receive radio-frequency signals having a channel bandwidth of 1.4 MHz, 3 MHz, 5 MHz, or 10 MHz. In general, each LTE band imposes respective requirements on the allowable channel bandwidth. Each uplink and downlink channel in each LTE band may be identified by a respective channel number such as an Absolute Radio Frequency Channel Number (ARFCN), an E-UTRA Absolute Radio Frequency Channel Number (EARFCN), etc. In other words, each channel may be numbered to identify the channel. Each LTE band may include one or more dedicated control channels over which control signals and measurement data may be conveyed between device 10 and external equipment. Control channels may be formed from reserved resource blocks (i.e., resource blocks that have been assigned to a respective control channel).

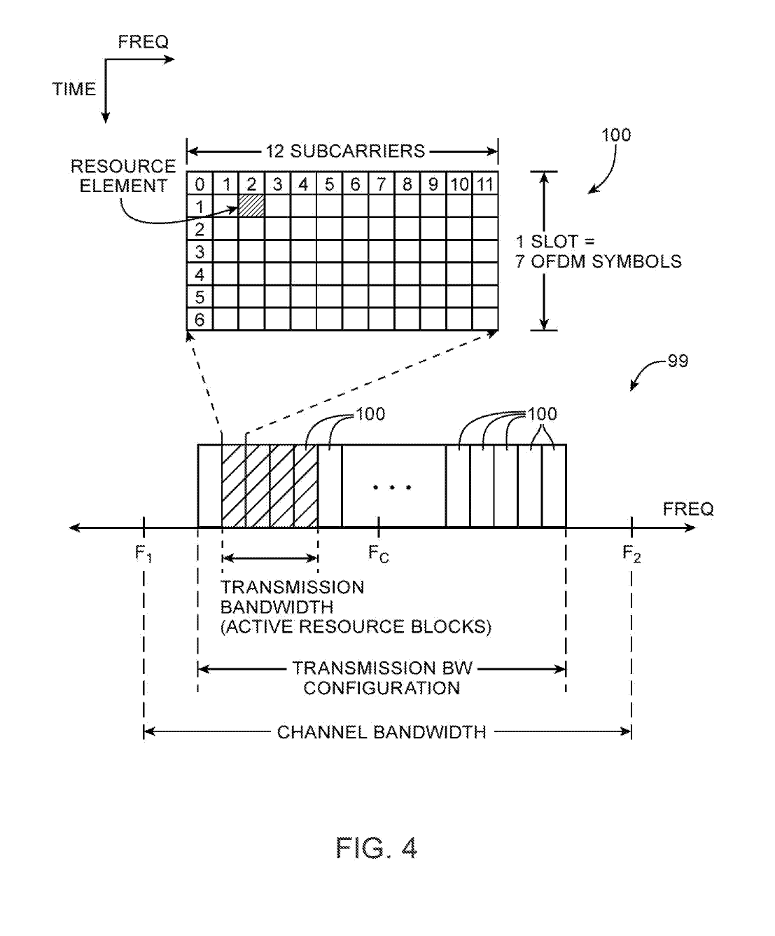

FIG. 4 shows an illustrative channel 98 centered about frequency F_{C}. Channel 98 may be any numbered channel in the uplink or downlink band of any desired LTE band (e.g., channel 98 may be any desired uplink or downlink channel). Channel 98 may have a lower channel edge bounded by frequency F₁ and an upper channel edge defined by frequency F₂ (e.g., channel 98 may have a channel bandwidth equal to F₂ minus F₁, where F_{C} is equal to half of the sum of F₂ and F₁).

The maximum number of available resource blocks 100 associated with a particular uplink or downlink channel may be defined as the transmission bandwidth configuration, which sets the maximum available (or occupied) bandwidth for transmission. The maximum available bandwidth may be computed by multiplying the transmission bandwidth configuration by 180 kHz (since each resource block has a bandwidth of 180 kHz in this example). The maximum available bandwidth is, by definition, less than or equal to the channel bandwidth. Generally, the number of resource blocks 100 making up the maximum available bandwidth increases as channel bandwidth increases.

As an example, a channel in the uplink band of a first LTE band may have a channel bandwidth of 10 MHz, a transmission bandwidth configuration of 50, and a maximum available bandwidth of 9 MHz (50*180 kHz). As another example, a channel in the downlink band of a second LTE band may have a channel bandwidth of 5 MHz, a transmission bandwidth configuration of 25, and a maximum available bandwidth of 4.5 MHz (25*180 kHz). As another example, a channel in the uplink band of a third LTE band may have a channel bandwidth of 3 MHz, a transmission bandwidth configuration of 15, and a maximum available bandwidth of 2.7 MHz (15*180 kHz). In general, channel 98 may have any suitable channel bandwidth (e.g., any suitable channel bandwidth allowed by the associated LTE band), a maximum available bandwidth that is less than or equal to the channel bandwidth and that is an integer multiple of the bandwidth of each resource block (e.g., an integer multiple of 180 kHz), and a transmission bandwidth configuration that is equal to the maximum available bandwidth divided by the resource block bandwidth.

As described previously in connection with FIG. 3, each resource block 100 may be formed with 12 consecutive subcarriers in the frequency domain, each of which is associated with 7 OFDM symbols in the time domain. The smallest modulation unit in LTE may be referred to as a resource element, which is defined as one 15 kHz subcarrier by one OFDM symbol. The time and frequency space spanned by one resource block 100 (e.g., 12 consecutive subcarriers by 6 or 7 consecutive OFDM symbols depending on whether the normal Cyclic Prefix or the extended Cyclic Prefix is currently in use) may be the smallest scheduling unit used by a user device such as device 10 to transmit and receive radio-frequency signals.

Device 10 need not utilize all of its available resource blocks 100. Device 10 may be configured to transmit or receive in only one resource block 100 or an allocated portion (e.g., a subset) of its resource blocks 100. If desired, device 10 may be configured to communicate in all available resource blocks. The number of active resource blocks that is allocated to device 10 may set its transmission bandwidth. The transmission bandwidth may, for example, be computed by multiplying the number of allocated (or active) resource blocks by the bandwidth of each resource block (e.g., 180 kHz). The transmission bandwidth is, by definition, less than or equal to the maximum available bandwidth (e.g., the number of active resource blocks cannot exceed the maximum number of available resource blocks). As an example, device 10 communicating in uplink and downlink channels having a channel bandwidth of 10 MHz and a transmission bandwidth configuration of 50 (e.g., a maximum available bandwidth of 9 MHz) may be configured to transmit and receive radio-frequency signals in only 10% of its available resource blocks, only 20% of its available resource blocks, only 49% of its available resource blocks, etc. In the example of FIG. 4, the four active resource blocks 100 allocated to device 10 may be positioned relatively close to frequency F₁.

In general, the transmission bandwidth may be assigned to any desired portion of the maximum available bandwidth (e.g., the allocated resource blocks 100 for device 10 may be positioned near frequency F₁, near frequency F_{C}, near frequency F₂, or within any suitable portion of the maximum available bandwidth).

During communications operations by wireless communications circuitry 4 in device 10, antenna structures 34 may be used to simultaneously transmit uplink signals and receive downlink signals (e.g., wireless communications circuitry 4 may receive downlink signals in a channel of a downlink band and transmit uplink signals in a channel of an uplink band simultaneously). Duplexer 58 (FIG. 1) may partition radio-frequency signals provided at output path 30 into respective uplink and downlink signals. For example, duplexer 58 may include a high pass filter that routes signals at LTE downlink frequencies (i.e., downlink signals) from antenna structures 34 to receive path 56. Duplexer 58 may include a low pass filter that passes signals at LTE uplink frequencies (i.e., uplink signals) from transmit path 54 to output path 30. This example is merely illustrative. If desired, duplexer 58 may include a high pass filter for LTE uplink frequencies and a low pass filter for LTE uplink frequencies or may include any desired combination of filters such as band pass filters, high pass filters, and/or low pass filters for isolating uplink and downlink signals. Duplexer 58 may pass downlink signals from output path 30 to receive path 56 while isolating receive path 56 from uplink signals. Similarly, duplexer 58 may pass uplink signals from transmit path 54 to output path 30 while isolating transmit path 54 from received downlink signals. In this way, duplexer 58 may isolate uplink and downlink signals during communications operations.

A number of radio-frequency parameters may affect the amount of interference between uplink and downlink paths in wireless communications circuitry 4. For example, uplink signals transmitted at higher signal power levels may produce increased interference with downlink signals on receive path 56 (e.g., uplink signals at higher signal power levels may produce increased interference relative to uplink signals produced at a lower signal power). As another example, uplink signals having increased transmission bandwidth may produce increased levels of self-interference relative to uplink signals having reduced transmission bandwidth. In scenarios in which duplexer 58 provides insufficient isolation between uplink and downlink signals during communications operations, uplink signals may undesirably interfere with downlink signals conveyed from output path 30 to receive path 56. This interference may cause undesirable distortion or errors in the downlink communications.

Downlink signals received by antennas 34 may include a digital data stream having a series of binary bits “1” and “0.” The digital data stream may, for example, be encoded using a desired modulation scheme (e.g., QPSK, 16-QAM, 64-QAM, etc.). Baseband module 18 may extract the digital data stream from the downlink signals. The number of bits in the digital data stream that are successfully retrieved by baseband module 18 per second may be defined as the data reception throughput (sometimes referred to as data throughput or receive path data throughput) of wireless communications circuitry 4. Interference between uplink and downlink signals may produce errors in some of the bits in the downlink digital data stream (e.g., insufficient isolation provided by duplexer 58 between uplink and downlink paths may reduce the data throughput of circuitry 4).

Radio-frequency performance of wireless communications circuitry 4 may be characterized by a performance metric such as data reception throughput. Radio-frequency testing may be performed on wireless communications circuitry 4 to determine whether circuitry 4 satisfies performance metrics. If desired, any suitable performance metric (e.g., receiver sensitivity, etc.) may be used to characterize the radio-frequency performance of wireless communications circuitry 4.

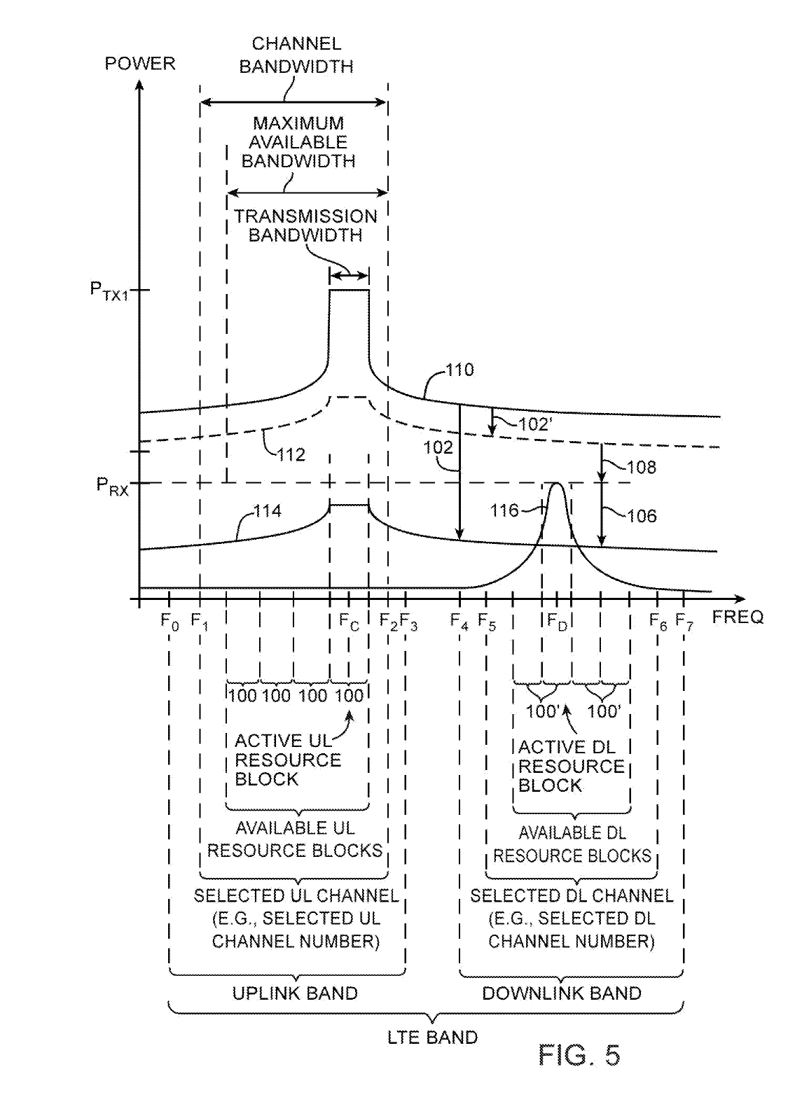

A graph showing how uplink signals transmitted by wireless communications circuitry 4 may interfere with downlink signals received by wireless communications circuitry 4 is shown in FIG. 5. Curve 110 illustrates signal power levels of uplink signals transmitted by wireless communications circuitry 4 (e.g., output power levels of uplink signals conveyed by duplexer 58 from transmit path 54 to output path 30).

In the example of FIG. 5, wireless communications circuitry 4 is configured to transmit and receive radio-frequency signals in a frequency band between frequencies F₀ and F₇. The frequency band between frequencies Fₒ and F₇ may, for example, be an LTE band (e.g., LTE band 1, LTE band 2, etc.). Wireless communications circuitry 4 may be configured to transmit radio-frequency uplink signals in an uplink band between frequencies F₀ and F₃ (e.g., in an uplink band associated with the desired LTE band). Wireless communications circuitry 4 may transmit radio-frequency signals in a selected uplink channel between frequencies F₁ and F₂. The selected uplink channel may be identified by a channel number. The selected uplink channel may include a number of resource blocks. Resource blocks used for uplink communications by wireless communications circuitry 4 may sometimes be referred to as uplink resource blocks. In the example of FIG. 5, four uplink resource blocks 100 are available in the selected uplink channel (i.e., the transmission bandwidth configuration associated with curve 110 is four). This example is merely illustrative. If desired, the selected uplink frequency channel may include any desired number of available uplink resource blocks (e.g., 50 uplink resource blocks, 10 uplink resource blocks, etc.).

Wireless communications circuitry 4 may transmit radio-frequency signals in one or more active uplink resource blocks 100 (e.g., resource blocks that have been assigned to device 10). In the example of FIG. 5, device 10 may have been assigned an active uplink resource block 100 centered about frequency F_{C}. Wireless communications circuitry 4 may be configured to transmit signals at a desired uplink signal power level P_{TX1} in active uplink resource block 100. In the example of FIG. 5, the transmission bandwidth associated with curve 110 is the same as the bandwidth of active uplink resource block 100, because wireless communications circuitry 4 is only transmitting radio-frequency signals in one uplink resource block 100. In general, the transmission bandwidth may correspond to the number of active resource blocks.

Wireless communications circuitry 4 may be configured to receive radio-frequency downlink signals in a downlink band between frequencies F₄ and F₇ (e.g., in a downlink band associated with the desired LTE band). Wireless communications circuitry 4 may receive radio-frequency downlink signals in a selected downlink channel between frequencies F₅ and F₆ (e.g., a selected downlink channel within the downlink band). The selected downlink channel may be identified by a channel number. The selected downlink channel may include a number of resource blocks. Resource blocks used for downlink communications by wireless circuitry 4 may sometimes be referred to as downlink resource blocks. In the example of FIG. 4, four downlink resource blocks 100′ are available in the selected downlink channel. This example is merely illustrative. If desired, the selected downlink frequency channel may include any desired number of available downlink resource blocks.

Curve 116 illustrates signal power levels of radio-frequency downlink signals received by wireless communications circuitry 4. Radio-frequency downlink signals associated with curve 116 may, for example, be produced by a base station such as base station 6 of FIG. 1. In the example of FIG. 5, base station 6 may transmit radio-frequency downlink signals in an active downlink resource block 100′ centered about frequency F_{D}. As shown by curve 116, downlink signals received and isolated by duplexer 58 may have a signal power level P_{RX}. Signal power level P_{RX} may sometimes be referred to as a receive power level.

Wireless communications circuitry such as circuitry 4 may be subject to manufacturing tolerances and other sources of variance. Wireless communications circuitry 4 that is subject to excessive deviation from a desired design during manufacturing may provide unsatisfactory levels of isolation between uplink (transmit) and downlink (receive) paths.

A portion of uplink signals that are transmitted on transmit path 54 may undesirably pass through duplexer 58 to receive path 56 when duplexer 58 provides insufficient isolation. The portion of uplink signals that pass from output path 30 to receive path 56 may sometimes be referred to herein as interfering transmit signals or “leaked uplink signals.” Due to isolation provided by duplexer 58, leaked uplink signals may have less overall signal power than the corresponding uplink signals provided to output path 30 from transmit path 54. For example, leaked uplink signals may have signal power levels that are less than the signal power levels associated with curve 110 by isolation margin 102, as illustrated by curve 114. Isolation margin 102 may represent the isolation provided by duplexer 58 between transmit and receive paths. In the example of FIG. 5, receive power level P_{RX} is greater than the power level of the leaked uplink signals associated with curve 114 in active downlink resource block 100′ by margin 106. In this scenario, the downlink signals associated with curve 116 may be adequately received by transceiver circuitry 14, because leaked uplink power level 114 may cause minimal interference with downlink signals received at power level P_{RX}.

Due to manufacturing tolerances or other sources of variance, duplexer 58 may provide insufficient isolation between transmit and receive paths as shown by curve 112. As shown by curve 112, duplexer 58 may provide isolation margin 102′ such that uplink signal power 110 leaks to receive path 56 with leaked signal power 112. Isolation margin 102′ is less than isolation margin 102 associated with curve 114. Receive power level P_{RX} is less than the signal power level of the leaked uplink signals associated with curve 112 in active downlink resource block 100′ by margin 108.

Curve 112 may represent leaked uplink signals that unacceptably interfere with downlink signals conveyed to receive path 56 (i.e., the signals associated with curve 116), because receive power level P_{RX} is less than the corresponding signal power level associated with curve 112. In this scenario, there may be a significant amount of interference between leaked uplink signals and downlink signals provided to receive path 56. The downlink signals that are received by transceiver circuitry 14 may thereby have insufficient data reception throughput. In general, leaked uplink signals that unacceptably interfere with downlink signals may have a substantially similar or greater signal power within downlink frequencies than downlink signals. For example, leaked uplink signals that are within the same order of magnitude as receive power P_{RX} at downlink frequencies may cause unacceptable interference.

In the example of FIG. 5, wireless communications circuitry 4 is configured to transmit uplink signals in an active uplink resource block 100 with a maximum uplink signal power level P_{TX1} (e.g., the maximum output power level of power amplifier circuitry 50). If desired, wireless communications circuitry 4 may be configured to transmit uplink signals in any desired subset of uplink resource blocks or all available uplink resource blocks 100. It may be desirable to configure wireless communications circuitry 4 to transmit uplink signals in one active uplink resource block 100 with a maximum uplink signal power level or in all available uplink resource blocks 100 while performing test operations on wireless communications circuitry 4.

Wireless communications circuitry 4 may have transmit power capabilities that vary with how many resource blocks are active. As the number of active resource blocks increases, the maximum power level at which circuitry 4 transmits radio-frequency signals may be reduced. During test operations, it may be desirable to perform interference testing at reduced transmit power levels for configurations in which multiple resource blocks are active.

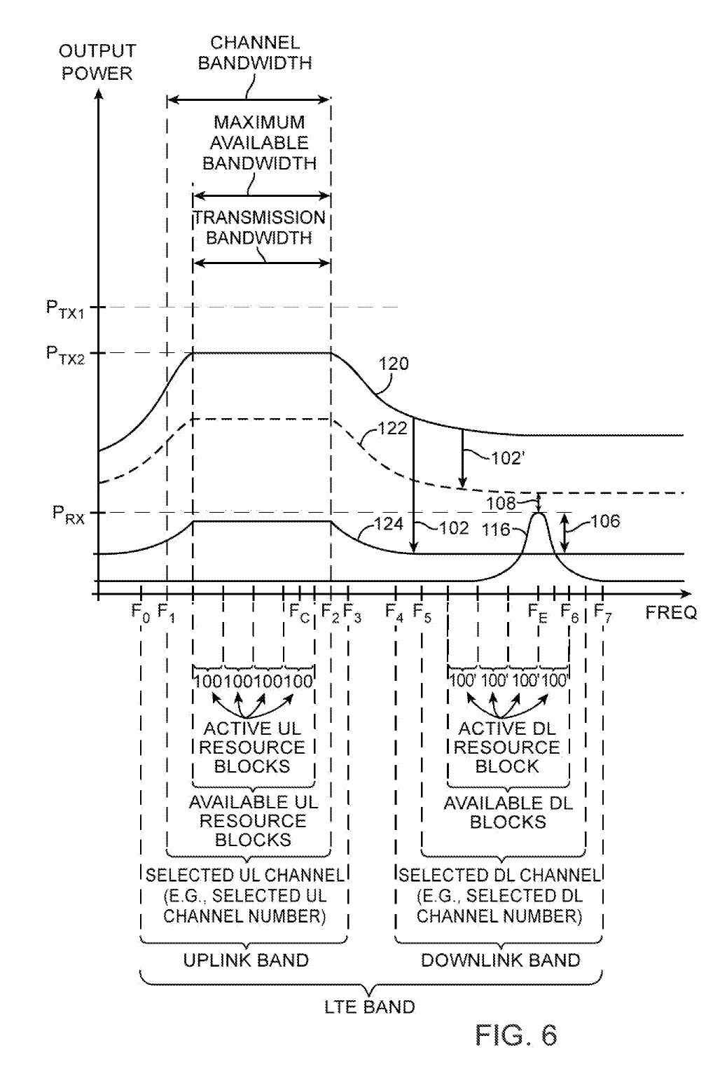

A graph illustrating radio-frequency performance of wireless communications circuitry 4 when configured to transmit in multiple resource blocks is shown in FIG. 6. In the example of FIG. 6, curve 120 illustrates signal power levels of uplink signals transmitted by wireless communications circuitry 4 using all available uplink resource blocks 100 (e.g., all available uplink resource blocks 100 are active).

As shown in FIG. 6, all four available uplink resource blocks 100 in the selected uplink channel are used to transmit uplink signals. Wireless communications circuitry 4 may be configured to transmit signals at a maximum uplink signal power level P_{TX2} that is less than output power level P_{TX1}.

Curve 122 may represent leaked uplink signals that unacceptably interfere with downlink signals conveyed to receive path 56 (i.e., the signals associated with curve 116), because receive power level P_{RX} is less than the corresponding signal power level associated with curve 122. In this scenario, there may be a significant amount of interference between leaked uplink signals and downlink signals provided to receive path 56. The downlink signals received by transceiver circuitry 14 may thereby have insufficient data reception throughput.

Curve 124 may represent leaked uplink signals that do not unacceptably interfere with downlink signals conveyed to receive path 56 (i.e., the signals associated with curve 116), because the power level associated with curve 124 in active downlink resource block 100′ is substantially less than receive power level P_{RX}. In this scenario, the downlink signals associated with curve 116 may be adequately received by transceiver circuitry 14, because leaked uplink power level 124 may cause minimal interference with downlink signals at receive path 56. The downlink signals received by transceiver circuitry 14 may thereby have sufficient data reception throughput.

FIGS. 5 and 6 are merely illustrative. If desired, any number and combination of uplink resource blocks 100 may be used by wireless communications circuitry 4 to transmit uplink signals. Similarly, any number and combination of downlink resource blocks 100′ may be used by base station 6 to transmit downlink signals to wireless communications circuitry 4. Testing systems may be provided to test data reception throughput in wireless communications circuitry 4 under a number of different uplink and downlink signal configurations.

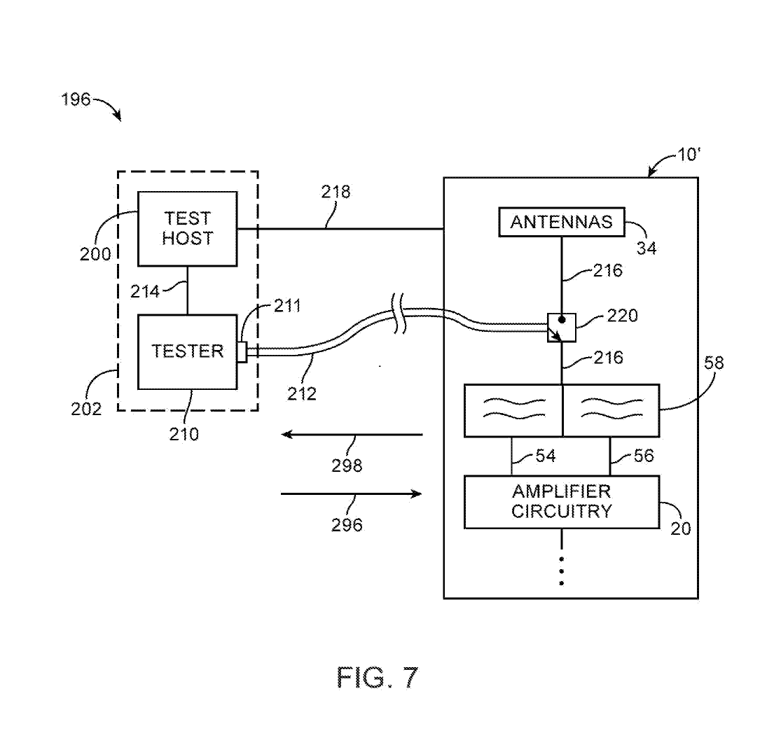

Testing systems such as test system 196 of FIG. 7 may be used to test the radio-frequency performance of wireless communications circuitry 4 in device 10. As shown in FIG. 7, test system 196 may include test host 200 (e.g., a personal computer, laptop computer, tablet computer, handheld computing device, etc.) and a testing unit such as tester 210. Test host 200 and/or tester 210 may include storage circuitry. Storage circuitry in test host 200 and tester 210 may include one or more different types of storage such as hard disk drive storage, nonvolatile memory (e.g., flash memory or other electrically-programmable-read-only memory), volatile memory (e.g., static or dynamic random-access-memory), etc. Wireless communications circuitry that is being tested using tester 210 and test host 200 may be referred to as device under test (DUT) 10′. DUT 10′ may be, for example, a fully assembled electronic device such as electronic device 10 or a partially assembled electronic device (e.g., DUT 10′ may include some or all of wireless circuitry 4 prior to completion of manufacturing). It may be desirable to test partially assembled electronic devices such as wireless communications circuitry 4 that have not yet been enclosed with an electronic device housing (e.g., for more convenient access by test equipment).

Tester 210 may include a signal generator, a spectrum analyzer, a radio communications analyzer, a vector network analyzer, or any other equipment suitable for generating radio-frequency test signals and for performing radio-frequency measurements on signals received from DUT 10′. In other suitable arrangements, tester 210 may be a radio communications test unit of the type that is sometimes referred to as a call box or a base station emulator. Test unit 210 may be used to emulate the behavior of a base transceiver station (e.g., base station 6 of FIG. 1) to test the radio-frequency performance of wireless communications circuitry 4 using communications protocols such as the 2G GSM and CDMA, 3G cellular telephone communications protocols such as UMTS and EV-DO, 4G cellular telephone communications protocols such as LTE, and other suitable cellular telephone communications protocols.

Tester 210 may be operated directly or via computer control (e.g., when test unit 210 receives commands from test host 200). When operated directly, a user may control tester 210 by supplying commands directly to tester 210 using a user input interface of tester 210. For example, a user may press buttons in a control panel on tester 210 while viewing information that is displayed on a display in test unit 210. In computer controlled configurations, test host 200 (e.g., software running autonomously or semi-autonomously on test host 200) may communicate with tester 210 by sending and receiving control signals and data over path 214. Test host 200 and tester 210 may optionally be formed together as test equipment 202. Test equipment 202 may be a computer, test station, or other suitable system that performs the functions of test host 200 and tester 202 (e.g., the functionality of test host 200 and tester 210 may be implemented on one or more computers, test stations, etc.).

During test operations, DUT 10′ may be coupled to test host 200 through wired path 218 (as an example). Connected in this way, test host 200 may send commands over path 218 to configure DUT 10′ to perform desired operations during testing. DUT 10′ may send data such as measurement data to test host 200 over path 218. Test host 200 and DUT 10′ may be connected using a Universal Serial Bus (USB) cable, a Universal Asynchronous Receiver/Transmitter (UART) cable, or other types of cabling (e.g., bus 219 may be a USB-based connection, a UART-based connection, or other types of connections).

DUT 10′ may be coupled to tester 210 through a radio-frequency cable such as radio-frequency test cable 212. DUT 10′ may include a radio-frequency switch connector 220 interposed in a transmission line path 216 connecting radio-frequency front-end circuitry duplexer 58 to antenna structures 34 (e.g., switch connector 220 may be interposed in path 30 as shown in FIG. 1). Test cable 212 may have a first terminal that is connected to a corresponding port in tester 210 via radio-frequency connector 211 and a second terminal that can be connected to switch connector 220. When mated with test cable 212, antenna structures 34 may be decoupled from duplexer 58. At the same time, radio-frequency switch connector 220 may electrically connect duplexer 58 and tester 210 via path 212. When cable 212 is coupled to DUT 10′ via switch connector 220, tester 210 may be configured to perform testing (e.g., radio-frequency test signals may be conveyed between tester 210 and duplexer 58). Cable 212 may include, for example, a miniature coaxial cable with a diameter of less than 2 mm (e.g., 0.81 mm, 1.13 mm, 1.32 mm, 1.37 mm, etc.), a standard coaxial cable with a diameter of about 2-5 mm, and/or other types of radio-frequency cabling. In another suitable arrangement, DUT 10′ may receive commands to perform desired test operations via cable 212 over one or more control channels in a selected LTE band.

Radio-frequency signals may be transmitted in a downlink direction (as indicated by arrow 296) from tester 210 to DUT 10 through cable 212. During downlink signal transmission, test host 200 may direct tester 210 to generate radio-frequency downlink signals that are provided to DUT 10′ through switch connector 218. Radio-frequency downlink signals that are provided to DUT 10′ during test operations may sometimes be referred to as test signals or downlink test signals.

Downlink test signals may include radio-frequency test data. Radio-frequency test data may include a sequence of digital bits (e.g., a data stream of digital bits). DUT 10′ may perform radio-frequency measurements such as data throughput measurements on the received test signals. Radio-frequency signals may also be transmitted in an uplink direction (as indicated by arrow 298) from DUT 10′ to tester 210 through cable 212. During uplink signal transmission, DUT 10′ may be configured to generate radio-frequency uplink signals while tester 210 receives the corresponding uplink signals. If desired, radio-frequency uplink signals and downlink test signals may be conveyed by cable 212 simultaneously. Tester 210 may provide downlink test signals to DUT 10′ and receive uplink signals from DUT 10′ simultaneously.

During test operations, test host 200 may instruct tester 210 to generate downlink test signals having desired signal properties (e.g., a desired frequency, signal power, etc.). Test host 200 may instruct DUT 10′ to generate uplink signals having desired signal properties (e.g., a desired frequency, signal power, etc.). For example, test host 200 may instruct tester 210 to transmit downlink test signals to DUT 10′ in an active downlink resource block 100′ as shown by curve 116 in FIGS. 5 and 6. Test host 200 may, for example, instruct DUT 10′ to transmit uplink signals to tester 210 in an active uplink resource block 100 with a maximum uplink signal power P_{TX1} as shown by curve 110 of FIG. 5. As another example, test host 200 may instruct DUT 10′ to transmit uplink signals to tester 210 in all available uplink resource blocks 100 with a reduced uplink signal power P_{TX2} as shown by curve 120 of FIG. 6.

During test operations, test host 200 may instruct DUT 10′ to perform measurements on downlink test signals received from tester 210. For example, test host 200 may instruct DUT 10′ to perform data throughput value measurements on test signals received from tester 210. DUT 10′ may subsequently pass measured data throughput values to tester 212 and test host 200 via cable 212 for analysis. For example, DUT 10′ may pass measured data throughput values to test host 200 using one or more control channels of a selected LTE band. As another example, DUT 10′ may pass measured data throughput values to test host 200 via path 218.

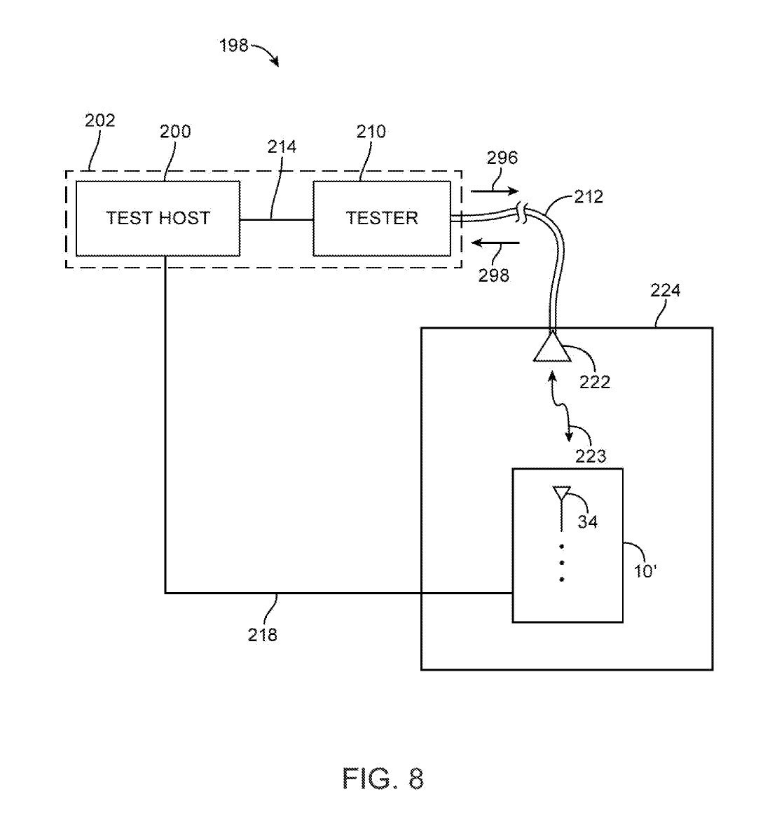

In another suitable arrangement, DUT 10′ may be tested using an over-the-air test station such as test station 198 as shown in FIG. 8. Test station 198 may include test host 200, tester 210, and a test enclosure such as test enclosure 224. Test host 200 and tester 210 may optionally be formed together as test equipment 202. Test equipment 202 may be a computer, test station, or other suitable system that performs the functions of test host 200 and tester 202.

During testing, at least one DUT 10′ may be placed within test enclosure 224. DUT 10′ may be coupled to test host 200 via control cable 218 (e.g., a USB-based connection or a UART-based connection). Test host 200 may send control signals over path 218 to instruct DUT 10′ to perform desired operations during testing. If desired, DUT 10′ may send measurement data obtained during testing to test host 200 over path 218.

Test enclosure 224 may be a shielded enclosure (e.g., a shielded test box) that can be used to provide radio-frequency isolation from the outside environment during testing. Test enclosure 224 may, for example, be a transverse electromagnetic (TEM) cell. The interior of test enclosure 224 may be lined with radio-frequency absorption material such as rubberized foam configured to minimize reflections of wireless signals. Test enclosure 224 may include wireless structures 222 in its interior for communicating with DUT 10′ using wireless radio-frequency signals. Wireless structures 222 may sometimes be referred to herein as test antennas 222. During wireless testing, wireless uplink and downlink signals may be passed between test antennas 222 and antennas 34 in DUT 10′ over path 223. As an example, wireless structures 222 may implement near field electromagnetic coupling with antennas 34 in DUT 10′ (e.g., coupling over ten centimeters or less). Wireless structures 222 in test enclosure 220 may include an inductor or other near field communications element (sometimes referred to as a near field communications test antenna or a near field communications coupler) used to receive near field electromagnetic signals from antennas 34 in DUT 10′.

Test antennas 222 may be coupled to test unit 210 via radio-frequency cable 212 (e.g., a coaxial cable). Test antenna 222 may be used during design or production test procedures to perform over-the-air testing on DUT 10′ (e.g., so that radio-frequency signals may be conveyed from DUT 10′ to tester 210 via antenna 222 and cable 212). Test antenna 222 may, as an example, be a microstrip antenna such as a microstrip patch antenna. During testing, radio-frequency uplink signals may be conveyed from DUT 10′ to tester 210 via test antenna 222 and radio-frequency cable 212 in the direction of arrow 298. Downlink test signals may be conveyed from tester 210 to DUT 10′ via radio-frequency cable 212 and test antenna 222 in the direction of arrow 296. DUT 10′ may, if desired, pass measured data throughput values to test host 200 via path 223 over one or more control channels of a selected LTE band. Test host 200 may, if desired, pass instructions to DUT 10′ for performing test operations via path 223 over one or more control channels of a selected LTE band.

As an example, DUT 10′ may transmit a number of “acknowledge” (ACK) data packets to tester 210 to acknowledge test data that are adequately received from tester 210 at DUT 10′. DUT 10′ may transmit ACK data packets to tester 210 via any suitable uplink channels of a selected LTE band (e.g., one or more uplink control channels of the selected LTE band). If desired, tester equipment 202 may measure ACK data packets received from DUT 10′ to determine data reception throughput values for DUT 10′. For example, tester 210 may transmit 100 test data packets to DUT 10′ and may receive 95 corresponding ACK packets from DUT 10′. In this scenario, test host 200 determines a data reception throughput value of 95% for DUT 10′.

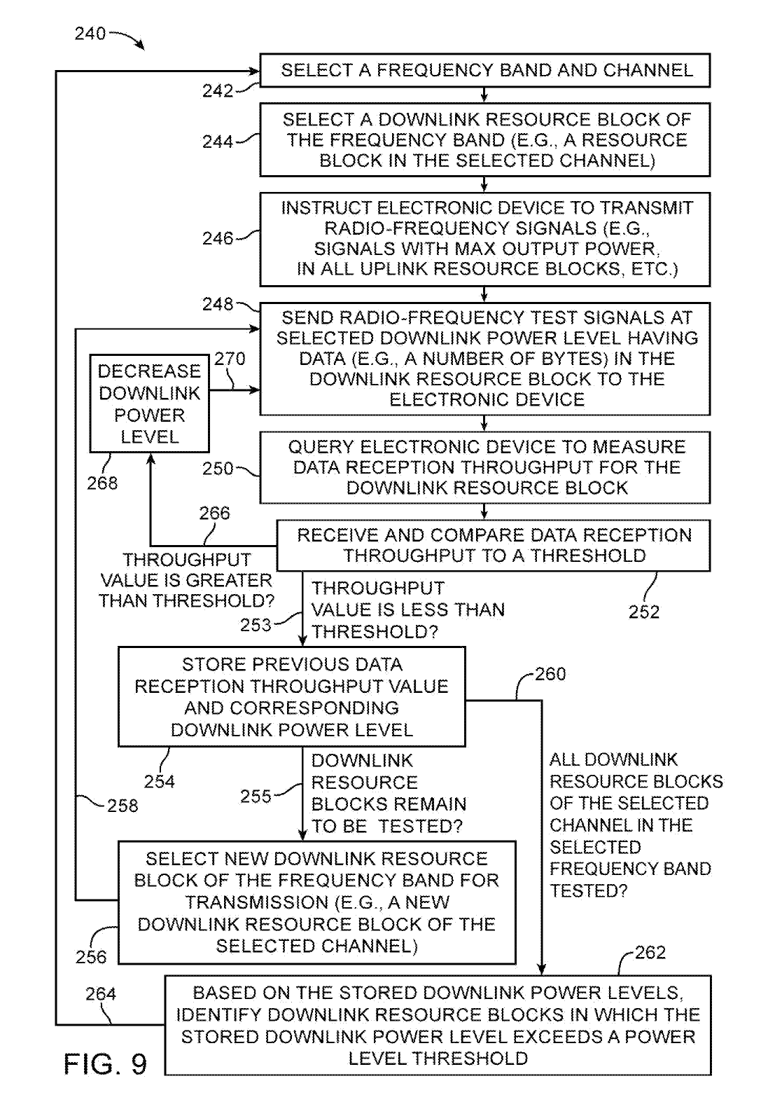

FIG. 9 is a flow chart 240 of illustrative steps that may be performed by test equipment such as test equipment 202 of FIGS. 7 and 8 to test the radio-frequency performance of wireless communications circuitry 4 in DUT 10′. The steps of flow chart 240 may be performed to identify radio-frequency performance of wireless devices. For example, the steps of flow chart 240 may be performed to identify wireless devices that have insufficient isolation between downlink and uplink paths (e.g., to identify wireless devices that have excessive leaked uplink signal power).

At step 242, test host 200 may select a frequency band for testing. The selected frequency band may be a communications band such as an LTE band (e.g., LTE band 1, 2, 3, etc.) between frequencies F₀ and F₇ as shown in FIGS. 5 and 6. The selected LTE band may include an associated uplink and downlink band. Test host 200 may select channel numbers within the LTE band that corresponds to respective uplink and downlink channels. The uplink channel may be partitioned into a number of available uplink resource blocks that serve as basic scheduling units for LTE communications (see, e.g., uplink resource blocks 100 of FIGS. 5 and 6). The downlink channel may be partitioned into a number of available downlink resource blocks (e.g., downlink resource blocks 100′ of FIGS. 5 and 6). The available resource blocks may each correspond to a respective set of frequency subcarriers and a respective time period (e.g., a set of consecutive OFDM symbols).

At step 244, test host 200 may select a downlink resource block 100′ from the available downlink resource blocks in the selected downlink channel for testing. Downlink resource block 100′ may be selected from any available downlink resource block in the selected downlink channel of the selected LTE band. For example, test host 200 may select a first downlink resource block 100′ centered at frequency F_{D} as shown in FIGS. 5 and 6.

At step 246, test host 200 instructs DUT 10′ to transmit radio-frequency uplink signals at a desired output power level in a selected uplink resource block 100. For example, test host 200 may instruct DUT 10′ to transmit uplink signals with a maximum uplink signal power level P_{TX1} in an active uplink resource block 100 centered about frequency F_{C}, as shown by curve 110 of FIG. 5. In another suitable arrangement, test host 200 may instruct DUT 10′ to transmit uplink signals with a reduced uplink signal power level P_{TX2} in multiple or all uplink resource blocks 100 of the available uplink resource blocks, as shown by curve 120 of FIG. 6.

At step 248, tester 210 transmits downlink test signals at a selected downlink power level to DUT 10′ in the selected downlink resource block. The downlink test signals may include a series of data bits (e.g., downlink test data). For example, tester 210 may transmit downlink test data to DUT 10′ in a downlink resource block 100′ centered about frequency F_{D} as shown by curve 116 of FIG. 5.

At step 250, test host 210 instructs DUT 10′ to measure a data reception throughput value in the selected downlink resource block 100′. DUT 10′ may maintain measured data reception throughput values of the test data received from tester 210. Interference between transmitted uplink signals and received test data may affect the data reception throughput values measured by DUT 10′ (e.g., interference may prevent some of the test data from being successfully received by transceiver circuitry 14 in DUT 10′). For example, DUT 10′ may measure a low data reception throughput value if there is excessive interference between the transmitted uplink signals and the received test data due to poor isolation performance of duplexer 58, whereas DUT 10′ may measure a high data reception throughput value when there is minimal interference between uplink and downlink paths.

At step 252, test host 200 retrieves the data reception throughput value measured in selected downlink resource block 100′ from DUT 10′. The data reception throughput value may be received via control channels of the LTE frequency band (e.g., test host 200 may instruct DUT 10′ to transmit the data reception throughput values over dedicated control channels using the LTE protocol or test host 200 may determine data reception throughput based on how many data packets are acknowledged by DUT 10′ via the control channels). Test host 200 may compare the data reception throughput value retrieved from DUT 10′ to a predetermined data reception throughput threshold. For example, the data reception throughput threshold may reflect a percentage of test data successfully received at DUT 10′ (e.g., 95%, 90%, or any other desired threshold percentage). If the measured data reception throughput value is greater than the data reception throughput threshold, processing may proceed to step 268 via path 266.

At step 268, tester 210 may decrease the power level of the transmitted downlink test signals. For example, tester 210 may decrement the downlink power level by one or more decibels (e.g., dBm). Processing may then loop back to step 248 via path 270 to measure data reception throughput values for the selected downlink resource block until the data reception throughput value measured at step 250 is less than the data reception throughput threshold.

If the measured data reception throughput value is less than the data reception throughput threshold, processing may proceed to step 254 via path 253. At step 254, the previous measured data reception throughput value and associated downlink power level may be stored. In other words, the minimum downlink power level that satisfies the data reception throughput threshold may be stored (e.g., the last measured data reception throughput value that is greater than the throughput threshold and the associated downlink power level may be stored).

If downlink resource blocks 100′ of the selected frequency band (e.g., downlink resource blocks in the selected downlink channel number of the frequency band) remain to be tested, processing may proceed to step 256 via path 255 to select a new downlink resource block 100′ for testing. Processing may then loop back to step 248 via path 258 to measure data reception throughput values for the selected downlink resource block.

If all desired downlink resource blocks 100′ of the selected frequency band (e.g., downlink resource blocks in the selected downlink channel number of the frequency band) have been tested (e.g., processed during steps 246-252), processing may proceed to step 262 via path 260. During the operations of step 262, test host 200 may compare the stored downlink power levels to a predetermined downlink power level threshold. In response to determining that the stored downlink power level for one or more downlink resource blocks 100′ is above the corresponding downlink power level threshold, test host 200 may determine that DUT 10′ fails testing. In other words, the stored data reception throughput information may be processed to identify resource blocks in which DUT 10′ is incapable of adequately receiving data at or below a power level threshold while simultaneously transmitting signals.

Devices under test that fail testing may be scrapped or, if desired, may be reworked. Downlink resource blocks 100′ corresponding to unacceptable downlink power levels may be flagged for subsequent analysis. In response to determining that the stored downlink power levels each satisfy the corresponding downlink power level threshold (e.g., that the stored downlink power levels are each less than the corresponding downlink power level threshold), test host 200 may determine that DUT 10′ passes testing. In this way, test equipment 202 may ensure that DUT 10′ provides sufficient radio-frequency isolation between signals received at a relatively low power level (e.g., at the power level threshold of step 262) and signals transmitted at a relatively high power level (e.g., maximum transmission power).

If desired, DUT 10′ may be identified as having unacceptable radio-frequency performance if the stored downlink power level for any desired number of downlink resource blocks 100′ exceeds a corresponding downlink power level threshold. For example, DUT 10′ may be characterized as having insufficient radio-frequency performance if the stored downlink power level in one or more downlink resource blocks 100′ fails to satisfy the corresponding downlink power level threshold. Determining whether DUT 10′ passes or fails testing may sometimes be referred to as performing pass-fail operations.

As shown by path 264, processing may loop back to step 242 after the radio-frequency performance of DUT 10′ has been characterized for the selected channels (e.g., for the selected uplink and downlink channels) in the selected frequency band. The radio-frequency performance may be tested for other selected channels in the selected frequency band and/or in other selected frequency bands (e.g., in other LTE bands). In this way, the radio-frequency performance of DUT 10′ may be tested for any desired number of different communications bands (e.g., in one or more LTE bands).

The steps shown in FIG. 9 are merely illustrative. If desired, the DUT 10′ may be controlled by test host 200 to transmit radio-frequency uplink signals in any number and combination of uplink resource blocks 100 (e.g., DUT 10′ may be instructed to transmit radio-frequency test signals in two consecutive uplink resource blocks, in three non-consecutive uplink resource blocks etc.). Test operations may be performed on any subset of the available downlink resource blocks 100′ in selected communications bands. For example, tester 210 may supply downlink test signals to DUT 10′ in any number of downlink resource blocks 100′. Test host 200 may configure DUT 10′ to measure data reception throughput values in any desired number of downlink resource blocks 100′.

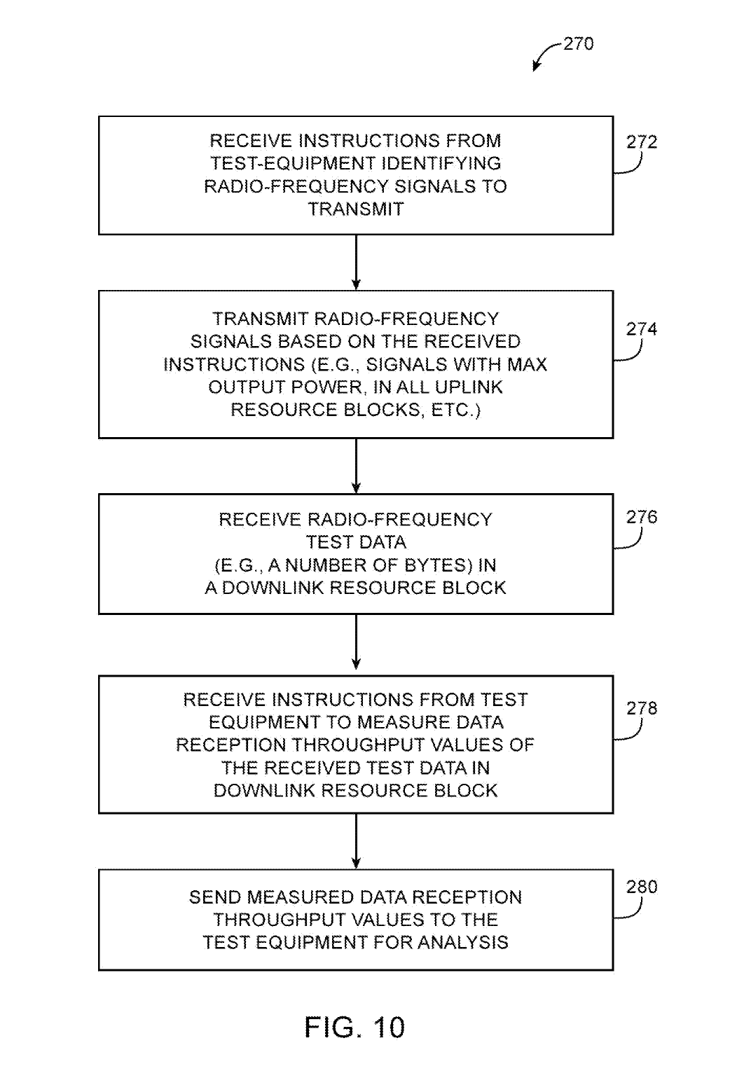

FIG. 10 shows a flow chart 270 of illustrative steps that may be performed by a device under test such as DUT 10′ during radio-frequency test operations.

At step 272, DUT 10′ receives instructions from test host 200 to transmit radio-frequency uplink signals to tester 210. The received instructions may identify a desired uplink signal power level and one or more desired uplink resource blocks 100 in which to transmit uplink signals.

At step 274, DUT 10′ transmits uplink signals in the desired uplink resource blocks 100 at the desired uplink signal power level. For example, DUT 10′ may transmit uplink signals with a maximum uplink signal power level P_{TX1} in an active uplink resource block 100 centered about frequency F_{C} as shown by curve 110 of FIG. 5. In another suitable arrangement, DUT 10′ may transmit uplink signals with a maximum uplink signal power level P_{TX2} in all available uplink resource blocks 100 in a selected channel of a selected frequency band as shown by curve 120 of FIG. 6.

At step 276, DUT 10′ may receive radio-frequency test data from tester 210. DUT 10′ may subsequently receive instructions from test host 200 to measure data reception throughput values of the received test data in a desired downlink resource block 100′ (step 278). DUT 10′ may measure data reception throughput values of the received test data in the desired downlink resource block 100′. For example, DUT 10′ may measure data reception throughput values in an active downlink resource block 100′ centered about frequency F_{D}. DUT 10′ may optionally store the data reception throughput values in memory. DUT 10′ may subsequently send the measured data reception throughput values to test host 200 for analysis (step 280). FIG. 10 is merely illustrative. If desired, test host 200 and/or tester 210 may measurer data reception throughput values associated with DUT 10′.

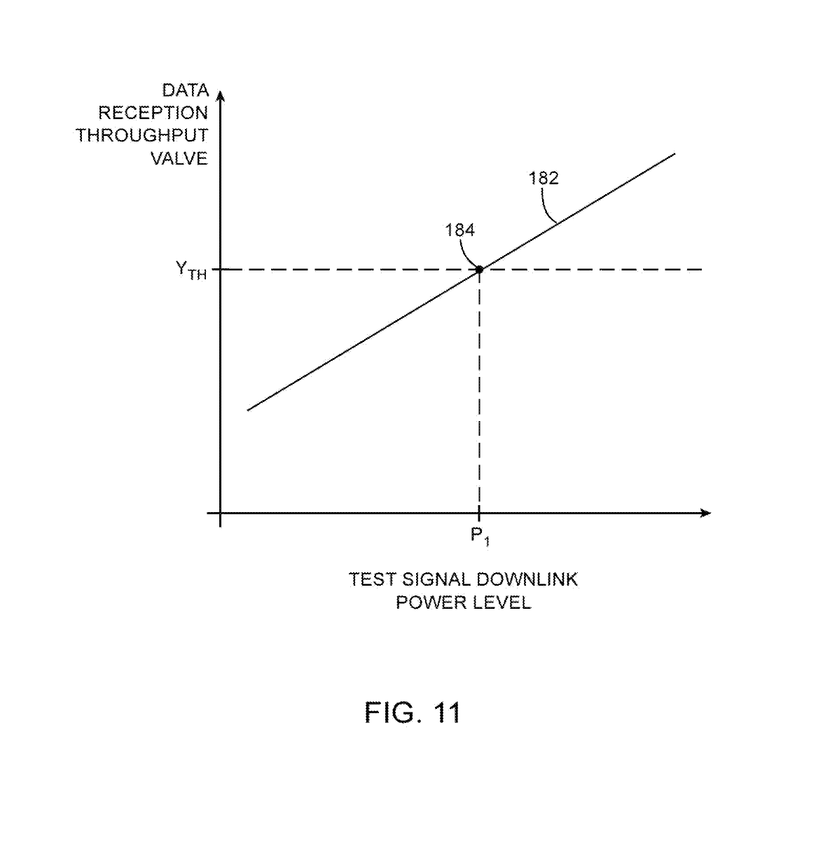

A graph showing an example of how measured data reception throughput values may be compared to a threshold data reception throughput value by test host 200 is shown in FIG. 11. As shown in FIG. 11, curve 182 illustrates data reception throughput values measured by DUT 10′ at different downlink power levels for a given downlink resource block 100′. Curve 182 may, for example, be obtained by performing steps 250, 252, and 268 of FIG. 9. As shown in FIG. 11, measured data reception throughput values may decrease as downlink power level is decremented. When the measured data reception throughput value is less than data reception throughput threshold Y_{TH}, the minimum downlink power level that satisfies data reception throughput threshold Y_{TH} may be stored (e.g., downlink power level P₁ as shown by point 184 may be stored).

Threshold data reception throughput value Y_{TH} may be determined, for example, from carrier-imposed requirements, regulatory requirements, manufacturing requirements, design requirements, or any other suitable standards for the radio-frequency performance of DUT 10′. The threshold data reception throughput value may, if desired, be isolation requirements that limit radio-frequency interference between uplink and downlink signal paths in wireless communications circuitry 4.

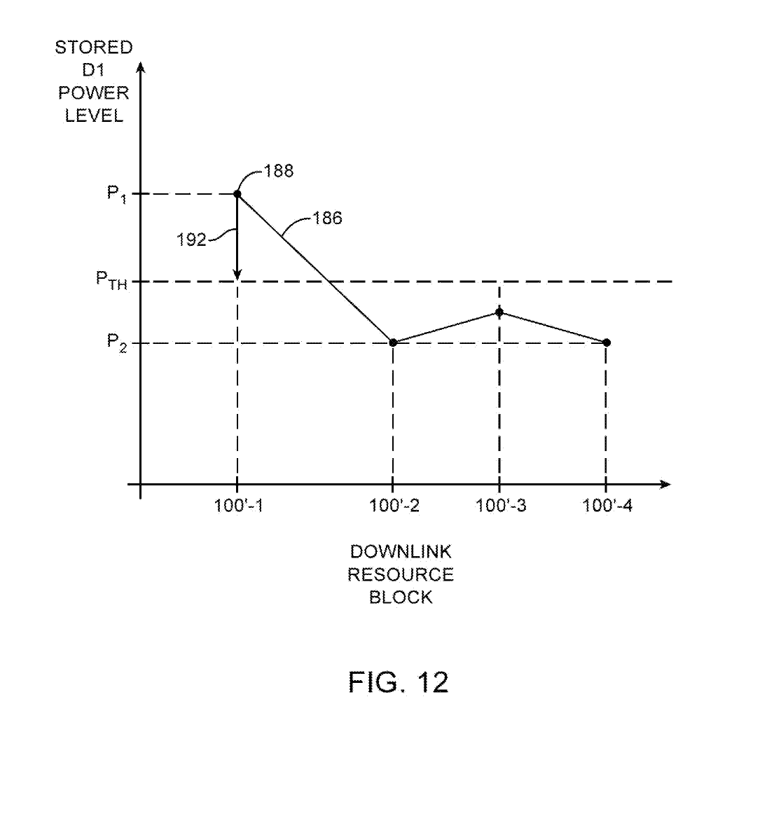

FIG. 12 is an illustrative graph showing how stored downlink power levels may be compared to a power level threshold. Curve 186 illustrates stored downlink power levels (e.g., minimum downlink power levels for which a measured data reception throughput value satisfies a data reception throughput threshold) at corresponding downlink resource blocks 100′ (e.g., a first downlink resource block 100′-1, a second downlink resource block 100′-2, etc.). Curve 186 may, for example, be obtained by processing step 262 of FIG. 9. The stored downlink power levels illustrated by curve 186 may be compared with downlink power level threshold P_{TH}. Downlink power level threshold P_{TH} may be determined, for example, from carrier-imposed requirements, regulatory requirements, manufacturing requirements, design requirements, or any other suitable standards for the radio-frequency performance of DUT 10′.

In the example of FIG. 12, downlink power levels are stored for four downlink resource blocks 100′ (e.g., downlink power level P₁ is stored for first downlink resource block 100′-1, an additional downlink power level P₂ is stored for second downlink resource block 100′-2, etc.). Point 188 may, for example, correspond to point 184 of FIG. 11, in which downlink power level P₁ is stored. Test host 200 may compare the stored downlink power levels to downlink power level threshold P_{TH}. In this example, test host 200 may determine that downlink power level P₁ is greater than downlink power level threshold P_{TH} by a margin 192. Test host 200 may determine that the stored downlink power level for downlink resource blocks 100′-2, 100′-3, and 100′-4 are all less than downlink power level threshold P_{TH} (e.g., the downlink power levels stored for downlink resource blocks 100′-2, 100′-3, and 100′-4 may “satisfy” or “pass” downlink power level threshold P_{TH}).

In this example, test host 200 may determine that DUT 10′ fails testing because stored downlink power level P₁ is greater than downlink power level threshold P_{TH}. DUT 10′ may subsequently be characterized as having insufficient radio-frequency performance (e.g., DUT 10′ may be characterized as having unacceptable interference between uplink and downlink signals in downlink resource block 100′-1).

The foregoing is merely illustrative of the principles of this invention and various modifications can be made by those skilled in the art without departing from the scope and spirit of the invention. The foregoing embodiments may be implemented individually or in any combination.

What is claimed is:

1. A method for testing wireless communications circuitry using test equipment, the method comprising:
configuring the wireless communications circuitry for communications using a frequency band that is partitioned into a plurality of resource blocks;
instructing the wireless communications circuitry to continuously transmit radio-frequency uplink signals in the frequency band;
transmitting radio-frequency downlink signals to the wireless communications circuitry in a selected resource block of the plurality of resource blocks; and
determining whether the uplink signals interfere with the downlink signals at the wireless communications circuitry.

2. The method defined in claim 1, wherein configuring the wireless communications circuitry for communications using the frequency band comprises:
configuring the wireless electronic device for communications in a channel identified by a channel number in the frequency band.

3. The method defined in claim 1 wherein configuring the wireless communications circuitry for communications in the frequency band comprises:
configuring the wireless communications circuitry for communications in a Long Term Evolution frequency band.

4. The method defined in claim 3 wherein determining whether the uplink signals interfere with the downlink signals at the wireless communications circuitry comprises:
identifying a data reception throughput value associated with the radio-frequency downlink signals transmitted in the selected resource block.

5. The method defined in claim 4, wherein determining whether the uplink signals interfere with the downlink signals at the wireless communications circuitry further comprises:
determining whether the identified data reception throughput value is less than a predetermined threshold.

6. The method defined in claim 5, further comprising:
identifying a downlink power level associated with the transmitted downlink signals at the predetermined threshold; and
determining whether the identified downlink power level is greater than a power level threshold.

7. The method defined in claim 3, wherein the Long Term Evolution frequency band is partitioned into a plurality of uplink resource blocks and wherein instructing the wireless communications circuitry to continuously transmit radio-frequency uplink signals in the frequency band comprises:
instructing the wireless communications circuitry to continuously transmit radio-frequency uplink signals in a selected uplink resource block in the plurality of uplink resource blocks.

8. The method defined in claim 7, wherein instructing the wireless communications circuitry to continuously transmit radio-frequency uplink signals in the selected uplink resource block further comprises:
instructing the wireless communications circuitry to continuously transmit radio-frequency uplink signals in the selected uplink resource block at a maximum output power level of the wireless communications circuitry.

9. The method defined in claim 3, wherein the Long Term Evolution frequency band is partitioned into a plurality of uplink resource blocks and wherein instructing the wireless communications circuitry to continuously transmit radio-frequency uplink signals in the frequency band comprises:
instructing the wireless communications circuitry to continuously transmit radio-frequency uplink signals in multiple uplink resource blocks of the plurality of uplink resource blocks.

10. The method defined in claim 3, wherein the Long Term Evolution frequency band is partitioned into a plurality of downlink resource blocks and wherein transmitting the radio-frequency downlink signals to the wireless communications circuitry in the selected resource block comprises:
transmitting the radio-frequency downlink signals to the wireless communications circuitry in a selected downlink resource block of the plurality of downlink resource blocks.

11. The method defined in claim 10 further comprising:
transmitting additional radio-frequency downlink signals to the wireless communications circuitry in an additional downlink resource block of the plurality of downlink resource blocks; and
determining whether the uplink signals interfere with the additional downlink signals in the additional downlink resource block at the wireless communications circuitry.

12. The method defined in claim 11, wherein transmitting the radio-frequency downlink signals to the wireless communications circuitry in the selected downlink resource block comprises transmitting the radio-frequency downlink signals in the selected downlink resource block during a first time period and wherein transmitting the additional radio-frequency downlink signals to the wireless electronic device in the additional downlink resource block comprises transmitting the additional radio-frequency downlink signals in the additional downlink resource block during a second time period subsequent to the first time period.

13. The method defined in claim 11, wherein determining whether the uplink signals interfere with the downlink signals at the wireless communications circuitry comprises:
identifying a first data reception throughput value associated with the radio-frequency downlink signals transmitted in the selected downlink resource block; and
identifying a second data reception throughput value associated with the radio-frequency downlink signals transmitted in the additional downlink resource block.

14. The method defined in claim 13 further comprising:
determining whether the first data reception throughput value is less than a threshold data reception throughput value; and
in response to determining that the first data reception throughput value is less than the threshold data reception throughput value, identifying the wireless communications circuitry as failing test operations.

15. The method defined in claim 14, further comprising:
determining whether the second data reception throughput value is less than the threshold data reception throughput value.

16. A method for testing a wireless electronic device using test equipment, the method comprising:
with the test equipment, configuring the wireless electronic device for communications using a frequency band that is partitioned into uplink and downlink frequency ranges, wherein the uplink frequency range is partitioned into a plurality of uplink resource blocks and wherein the downlink frequency range is partitioned into a plurality of downlink resource blocks;
with the test equipment, instructing the wireless electronic device to continuously transmit signals in at least one uplink resource block;
with the test equipment, transmitting radio-frequency data signals to the wireless electronic device in a selected downlink resource block; and
with the test equipment, identifying data reception throughput of the radio-frequency data signals in the selected downlink resource block measured by the wireless electronic device.

17. The method defined in claim 16, wherein the frequency band comprises a Long Term Evolution frequency band including channels having corresponding channel numbers and wherein configuring the wireless electronic device for communications using the frequency band further comprises:
configuring the wireless electronic device for communications using a selected channel of the Long Term Evolution frequency band.

18. The method defined in claim 16, wherein the wireless electronic device includes an uplink signal path and a downlink signal path and wherein the wireless electronic device is subject to isolation requirements that limit radio-frequency interference between the uplink and downlink signal paths, the method comprising:
based on the identified data reception throughput of the radio-frequency data signals in the selected downlink resource block, determining whether radio-frequency isolation between the uplink and the downlink signal paths satisfies the isolation requirements.

19. The method defined in claim 18 wherein determining whether the radio-frequency isolation between the uplink and the downlink signal paths satisfies the isolation requirements comprises:
determining whether the identified data reception throughput of the radio-frequency data signals in the selected downlink resource block is less than a threshold data reception throughput; and
in response to determining that the identified data reception throughput of the radio-frequency data signals in the selected downlink resource block is less than the threshold data reception throughput, notifying a user that the wireless electronic device fails testing.

20. A test system configured to test a wireless electronic device, the test system comprising:
test equipment that wirelessly communicates with the wireless electronic device, wherein the test equipment is configured to instruct the wireless electronic device to transmit radio-frequency uplink signals in a frequency band that is partitioned into a plurality of resource blocks, wherein the test equipment transmits test signals to the wireless electronic device in a selected resource block of the plurality of resource blocks, and wherein the test equipment identifies data reception throughput of the transmitted test signals at the wireless electronic device.

21. The test system defined in claim 20, wherein the frequency band includes an uplink channel and a downlink channel, wherein the uplink channel is partitioned into a plurality of uplink resource blocks, wherein the downlink channel is partitioned into a plurality of downlink resource blocks, wherein the test equipment instructs the wireless electronic device to continuously transmit radio-frequency uplink signals in at least one uplink block of the plurality of uplink resource blocks, and wherein the test equipment transmits test signals to the wireless electronic device in a selected downlink resource block of the plurality of downlink resource blocks.

22. The test system defined in claim 20, wherein the test equipment comprises a tester and a test host, wherein the tester is configured to gather data reception throughput values from the wireless electronic device, wherein the tester is configured to pass the data reception throughput values to the test host, and wherein the test host is configured to perform pass-fail test operations on the wireless electronic device by determining whether the data reception throughput values are less than predetermined threshold data reception throughput values.

23. The test system defined in claim 20, wherein the test equipment transmits test signals to the wireless electronic device in a resource block within a Long Term Evolution frequency band, wherein the wireless electronic device is configured to monitor data reception throughput values of the test signals, and wherein the test equipment instructs the wireless electronic device to transmit the data reception throughput values to the test equipment using the Long Term Evolution frequency band.
